(19) United States
(12) Patent Application Publication
(10) Pub. No.: US 2025/0277661 A1
(43) Pub. Date: Sep. 4, 2025

(54) THREE DIMENSIONAL SCANNING APPARATUS

(71) Applicant: QISDA CORPORATION, Taoyuan City (TW)

(72) Inventors: Chih-Ming Hu, Taoyuan City (TW); Tsung-Hsun Wu, Taoyuan City (TW)

(73) Assignee: QISDA CORPORATION, Taoyuan City (TW)

(21) Appl. No.: 19/014,129

(22) Filed: Jan. 8, 2025

(30) Foreign Application Priority Data
Feb. 29, 2024 (CN) 202410232055.9

(51) Int. Cl. G01B 11/25; G01B 9/08

(52) U.S. Cl. CPC G01B 11/2545; G01B 9/08; G01B 11/2513

(57) ABSTRACT

A three dimensional scanning apparatus is used to detect a contour of an object, and includes an illumination light source, a first aperture element, a reference pattern generator and an optical receiver. The illumination light source emits an illumination beam. The reference pattern generator provides a reference pattern by projection of the illumination beam, and transmits the reference pattern toward the object via the first aperture element. The optical receiver receives a detection pattern reflected from the object, so as to analyze difference between the reference pattern and the detection pattern for acquiring the contour. The first aperture element has two first lateral sides and two second lateral sides opposite to each other. A first length of one of the first lateral sides is greater than a second length of one of the second lateral sides.

### BACKGROUND OF THE INVENTION

### 1. Field of the Invention

The present invention relates to a three dimensional scanning apparatus, and more particularly, to a three dimensional scanning apparatus of keeping the scanning depth of field and the pattern's intensity.

### 2. Description of the Prior Art

With the advanced technology, optical scanning technology is widely used in various fields, such as the oral scanner. The conventional optical oral scanner utilizes a light source to project illumination light onto the grating, and the grating pattern reflected by the grating is projected onto the target object through the first aperture. The target object then reflects the grating pattern to pass through the second aperture and be received by the image capturing device. The first aperture and the second aperture of the conventional optical oral scanner are designed as a non-elliptical pinhole or an elliptical pinhole. Design of the non-elliptical pinhole results in low image capturing quality due to effect of the amount of light received by the image capturing device; design of the elliptical pinhole may increase the amount of light received by the image capturing device, but an intensity of the image captured by the image capturing device is still insufficient. Therefore, design of an optical scanning system of keeping the scanning depth of field and the image intensity in the low illumination environment is an important issue in the related optical design industry.

### SUMMARY OF THE INVENTION

The present invention provides a three dimensional scanning apparatus of keeping the scanning depth of field and the pattern's intensity for solving above drawbacks.

According to the claimed invention, a three dimensional scanning apparatus of detecting a contour of an object includes an illumination light source, a first aperture element, a reference pattern generator and an optical receiver. The illumination light source is adapted to emit an illumination beam. The reference pattern generator is adapted to provide a reference pattern by the illumination beam, and project the reference pattern onto the object through the first aperture element. The optical receiver is adapted to receive a detection pattern reflected from the object, so as to analyze difference between the reference pattern and the detection pattern for acquiring the contour. The first aperture element has two first lateral sides opposite to each other and two second lateral sides opposite to each other, a first length of one of the first lateral sides is greater than a second length of one of the second lateral sides.

According to the claimed invention, a ratio of the first length to the second length is ranged between 1:1 and 1:5, the two first lateral sides have the same length or different lengths, the two second lateral sides have the same length or different lengths. The first lateral side and the second lateral side respectively are a straight line. Or, the first lateral side is an arc line or a turning line, and a sum of internal angles of the first aperture element is smaller than 360 degrees.

According to the claimed invention, the reference pattern has a plurality of stripes arranged adjacent to each other, an extending direction of the first lateral side of the first aperture element is intersected with an arrangement direction of the plurality of stripes. An included angle between the extending direction of the first lateral side and the arrangement direction of the plurality of stripes is ninety degrees, or the extending direction is perpendicular to the arrangement direction and an angle error is allowed between the extending direction and the arrangement direction.

According to the claimed invention, the reference pattern has a plurality of stripes arranged adjacent to each other, the first lateral side of the first aperture element is extended in an extending direction of the plurality of stripes, so as to keep a scanning depth of field of the three dimensional scanning apparatus and increase an intensity of the detection pattern. In addition, the reference pattern has a plurality of stripes arranged adjacent to each other, the second lateral side of the first aperture element is shortened in an arrangement direction of the plurality of stripes, so as to keep an intensity of the detection pattern and increase a scanning depth of field of the three dimensional scanning apparatus.

According to the claimed invention, the three dimensional scanning apparatus further includes a second aperture element, the first aperture element and the second aperture element respectively are a quadrilateral aperture; the second aperture element has two first lateral sides opposite to each other and two second lateral sides opposite to each other, a first length of one of the first lateral sides is greater than a second length of one of the second lateral sides, a ratio of the first length to the second length is ranged between 1:1 and 1:1.15. A difference between a first ratio of the first lateral side to the second lateral side of the first aperture element and a second ratio of the first lateral side to the second lateral side of the second aperture element is smaller than a preset threshold. A first included angle of the first lateral side and/or the second lateral side of the first aperture element relative to the reference pattern is the same as or similar to a second included angle of the first lateral side and/or the second lateral side of the second aperture element relative to the reference pattern.

According to the claimed invention, a three dimensional scanning apparatus of detecting a contour of an object includes an illumination light source, a reference pattern generator, a second aperture element and an optical receiver. The illumination light source is adapted to emit an illumination beam. The reference pattern generator is adapted to provide a reference pattern by the illumination beam, and project the reference pattern onto the object. The optical receiver is adapted to receive a detection pattern reflected from the object through the second aperture element, so as to analyze difference between the reference pattern and the detection pattern for acquiring the contour. The second aperture element has two first lateral sides opposite to each other and two second lateral sides opposite to each other, a first length of one of the first lateral sides is greater than a second length of one of the second lateral sides.

According to the claimed invention, the second aperture element is a quadrilateral aperture, a ratio of the first length to the second length is ranged between 1:1 and 1:1.15, the two first lateral sides have the same length or different lengths, the two second lateral sides have the same length or different lengths, the first lateral side is a straight line or an arc line or a turning line, and a sum of internal angles of the second aperture element is smaller than 360 degrees.

According to the claimed invention, a three dimensional scanning apparatus of detecting a contour of an object includes an illumination light source, a first polygonal aperture element, a reference pattern generator and an optical receiver. The illumination light source is adapted to emit an illumination beam. The reference pattern generator is adapted to provide a reference pattern by the illumination beam, and project the reference pattern onto the object through the first polygonal aperture element. The optical receiver is adapted to receive a detection pattern reflected from the object, so as to analyze difference between the reference pattern and the detection pattern for acquiring the contour. The first polygonal aperture element comprises a first section, a second section and a third section adjacent to each other, the first section and the third section are respectively disposed on two opposite sides of the second section, an area of the second section is smaller than an area of the first section and/or the third section.

According to the claimed invention, the first polygonal aperture element has two staggered diagonal lines, and a length difference between the two diagonal lines is smaller than a preset threshold. The first section, the second section and the third section are connected adjacent to each other in a transverse direction, a structurally longitudinal dimension of the first section orthogonal to the transverse direction is greater than a structurally longitudinal dimension of the second section orthogonal to the transverse direction. Each lateral side of the first polygonal aperture element is an arc line or a straight line.

According to the claimed invention, a ratio of a maximal structurally lateral dimension to a minimal structurally longitudinal dimension of the first polygonal aperture element is ranged between 1:1 and 1:5. A minimal structurally longitudinal dimension of the second section is smaller than or equal to a minimal structurally longitudinal dimension of the first section and/or the third section.

According to the claimed invention, the three dimensional scanning apparatus further includes a second polygonal aperture element, the second polygonal aperture element comprises a first section, a second section and a third section adjacent to each other, the first section and the third section are respectively disposed on two opposite sides of the second section, an area of the second section is smaller than an area of the first section and/or the third section; and a ratio of a maximal structurally lateral dimension to a minimal structurally longitudinal dimension of the second polygonal aperture element is ranged between 1:1 and 1:1.15.

The three dimensional scanning apparatus of the present invention can be used for the optical molding apparatus in the dental department. A light source cannot put into the mouth of the patient, and an illumination efficiency of an external light source for projecting into the patient's mouth is insufficient, so that the optical system of the optical molding apparatus has to be advanced for preferred detection accuracy. Thus, the three dimensional scanning apparatus of the present invention can adjust the shape, the ratio and/or the size of the aperture element. The aperture element with specific design can significantly increase the penetration amount of illumination beam by comparing with the elliptical aperture, so as to stably maintain the scanning depth of field and the intensity of the pattern and further acquire the accurate and clear contour of the object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a three dimensional scanning apparatus according to an embodiment of the present invention.

FIG. 2 is an appearance diagram of a first aperture element according to a first embodiment of the present invention.

FIG. 3 is a front view of the first aperture element according to the first embodiment of the present invention.

FIG. 4 is a front view of the first aperture element according to a second embodiment of the present invention.

FIG. 5 is a front view of the first aperture element according to a third embodiment of the present invention.

FIG. 6 is a front view of the first aperture element according to a fourth embodiment of the present invention.

FIG. 7 is an appearance diagram of the first aperture element and a second aperture element according to the first embodiment of the present invention.

FIG. 8 is a diagram of relation between a reference pattern, a detection pattern, the first aperture element and the second aperture element according to the embodiment of the present invention.

FIG. 9 is a front view of a first polygonal aperture element according to a fifth embodiment of the present invention.

### DETAILED DESCRIPTION

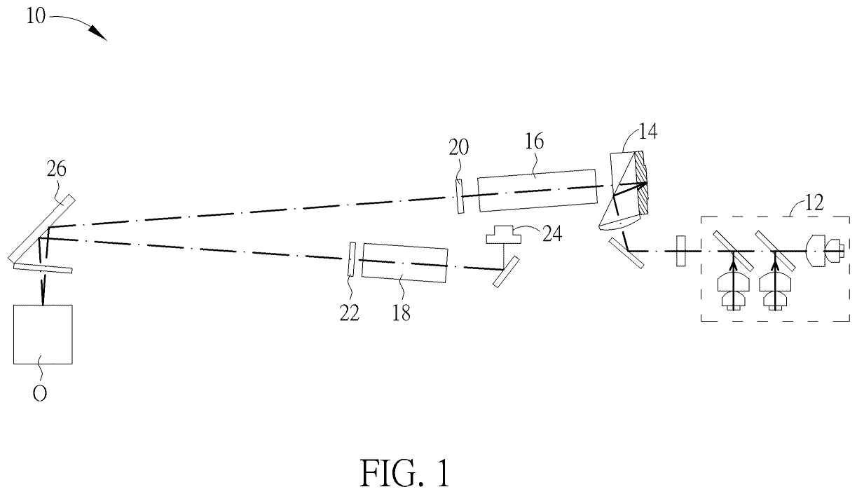

Please refer to FIG. 1. FIG. 1 is a diagram of a three dimensional scanning apparatus 10 according to an embodiment of the present invention. The three dimensional scanning apparatus 10 can detect a contour of an object O. The three dimensional scanning apparatus 10 can be an oral scanner or any related medical equipment, and the object O can be a tooth or other target object, which depends on an actual demand of the medical equipment. The three dimensional scanning apparatus 10 can include an illumination light source 12, a reference pattern generator 14, a projection lens assembly 16, an imaging lens assembly 18, a first aperture element 20, a second aperture element 22 and an optical receiver 24. The illumination light source 12 can emit an illumination beam in various wavelength ranges. For example, the illumination light source 12 can be a blue light emitter, or a combination of the blue light emitter and a green light emitter and a red light emitter, or a combination of the blue light emitter and a yellow light emitter, or a white light emitter, which depends on a design demand.

The reference pattern generator 14 can be a digital mirror device, or any element with similar functions. The illumination light source 12 can emit the illumination beam towards the reference pattern generator 14 for generating a reference pattern. The reference pattern can be projected onto a reflector 26 through a projection path of the projection lens assembly 16 and the first aperture element 20, and the reference pattern can be reflected by the reflector 26 to project onto the object O. The optical receiver 24 can receive a detection pattern of the object O through an imaging path of the imaging lens assembly 18 and the second aperture element 22, and analyze difference between the reference pattern and the detection pattern to acquire the contour of the object O. The optical receiver 24 can be a monochromatic light detector or a colorful light detector. The optical receiver 24 may include a processing unit used to directly analyze the difference between the reference pattern and the detection pattern for acquiring the contour of the object O; the optical receiver 24 may include a transmission unit used to transmit the detection pattern to an external computation module, and the external computation module can analyze the difference between the reference pattern and the detection pattern.

The projection lens assembly 16 can be located between the illumination light source 12 (and/or the reference pattern generator 14) and the object O. The imaging lens assembly 18 can be located between the optical receiver 24 and the object O. Each of the projection lens assembly 16 and the imaging lens assembly 18 can include a plurality of optical components, and any possible embodiment is omitted herein for simplicity. The first aperture element 20 can be an optical component installed inside the projection lens assembly 16, or can be an optical component independent of the projection lens assembly 16. The second aperture element 22 can be an optical component installed inside the imaging lens assembly 18, or can be an optical component independent of the imaging lens assembly 18. In this embodiment, the three dimensional scanning apparatus 10 can dispose the first aperture element 20 and the second aperture element 22 respectively on the projection path and the imaging path; however, practical application of the aperture elements is not limited to the foresaid embodiment. For example, the three dimensional scanning apparatus 10 of the present invention may preferably dispose the first aperture element 20 only on the projection path, or optionally dispose the second aperture element 22 only on the imaging path.

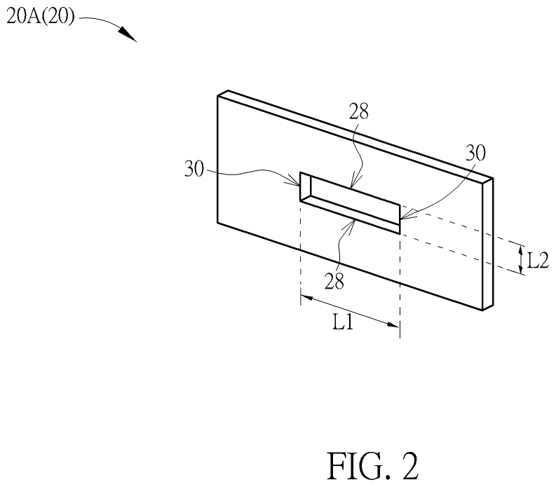

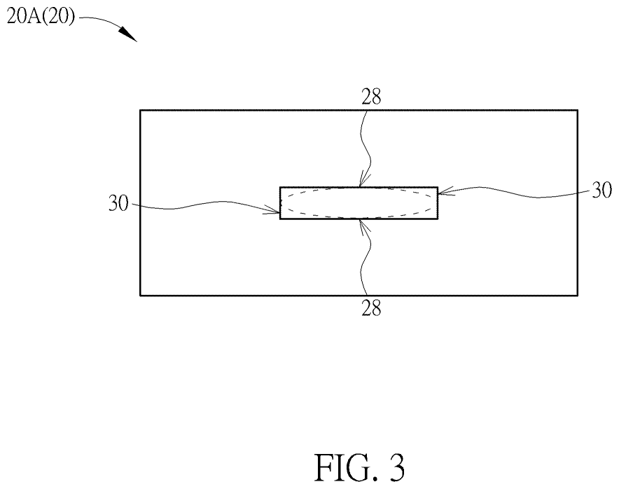

Structural features of the first aperture element 20 can be the same as or different from structural features of the second aperture element 22. The following description takes the first aperture element 20 as an example, but it can be applied for the second aperture element 22. Please refer to FIG. 2 and FIG. 3. FIG. 2 is an appearance diagram of the first aperture element 20A according to a first embodiment of the present invention. FIG. 3 is a front view of the first aperture element 20A according to the first embodiment of the present invention. The first aperture element 20A can have two first lateral sides 28 opposite to each other and two second lateral sides 30 opposite to each other. A first length L1 of the first lateral side 28 can be greater than a second length L2 of the second lateral side 30. Definition of an ellipse is a moving point trace where a sum of distances to two fixed points in the plane is constant, such as a dashed pattern shown in FIG. 3. The first aperture element 20A can be a quadrilateral aperture; by comparing the first aperture element 20A with the ellipse, the second length L2 of the second lateral side 30 can be the same as a length of a minor axis of the ellipse, and the first length L1 of the first lateral side 28 can be the same as a length of a major axis of the ellipse.

Therefore, the length of the first lateral side 28 of the first aperture element 20A can significantly increase the amount of received light, and the length of the second lateral side 30 of the first aperture element 20A can provide a preferred scanning depth of field, so as to keep or maintain the sufficient intensity of the detection pattern and further to acquire the accurate and clear contour of the object O. As shown in FIG. 2 and FIG. 3, a ratio of the first length L1 to the second length L2 can be preferably ranged between 1:1 and 1:5, and practical application of the ratio is not limited to the foresaid embodiment. For example, the length ratio of the long lateral side to the short lateral side of the second aperture element 22 (which may correspond to the first lateral side 28 and the second lateral side 30 of the first aperture element 20A) can be preferably ranged between 1:1 and 1:15. The first lateral side 28 and the second lateral side 30 of the first aperture element 20A can be straight lines, the two first lateral sides 28 can have the same length, and the two second lateral sides 30 can have the same length.

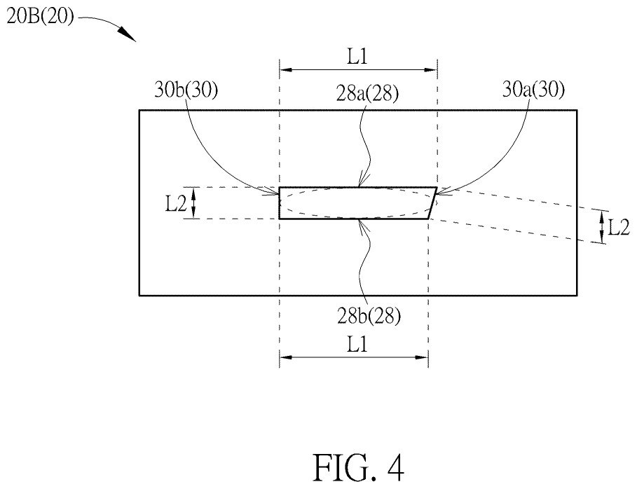

Please refer to FIG. 4. FIG. 4 is a front view of the first aperture element 20B according to a second embodiment of the present invention. The first aperture element 20B can have two first lateral sides 28 opposite to each other and two second lateral sides 30 opposite to each other. The first length L1 of the first lateral side 28 can be greater than the second length L2 of the second lateral side 30. The first aperture element 20B can be the quadrilateral aperture. By comparing the first aperture element 20B with the ellipse, the second length L2 of the second lateral side 30 can be the same as or similar to (such as longer or shorter) the length of the minor axis of the ellipse, and the first length L1 of the first lateral side 28 can be the same as or similar to (such as longer or shorter) the length of the major axis of the ellipse. In the second embodiment, the first length L1 of the upper first lateral side 28a can be different from the first length L1 of the lower first lateral side 28b, and a length difference between the upper first lateral side 28a and the lower first lateral side 28b can be smaller than a preset threshold; the second length L2 of the right second lateral side 30a can be different from the second length L2 of the left second lateral side 30b, and a length difference between the right second lateral side 30a and the left second lateral side 30b can be smaller than the preset threshold. An actual value of the preset threshold can depend on an overall size of the first aperture element 20B and the design demand of the three dimensional scanning apparatus 10, and a detailed description is omitted herein for simplicity.

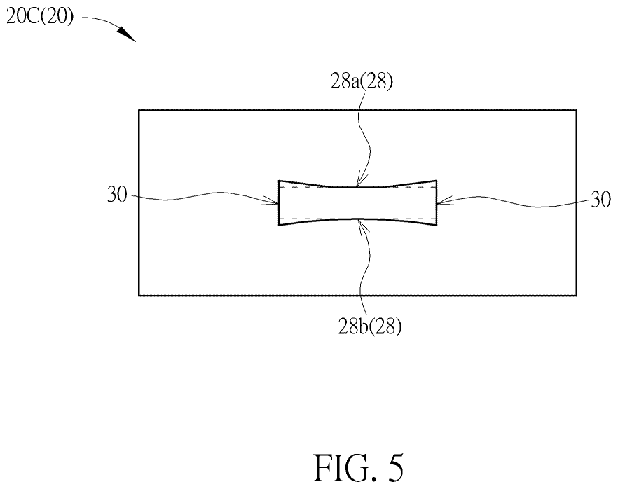

Please refer to FIG. 5. FIG. 5 is a front view of the first aperture element 20C according to a third embodiment of the present invention. The first aperture element 20C can have two first lateral sides 28 opposite to each other and two second lateral sides 30 opposite to each other. The first length of the first lateral side 28 can be greater than the second length of the second lateral side 30. The first aperture element 20C can be similar to the quadrilateral aperture, and the first lateral side 28 can be designed as the arc line or the turning line, so as to form a hole structure with wide sides and narrow middle. For example, the upper first lateral side 28a can be the turning line, and the lower first lateral side 28b can be the arc line; line types of the first lateral sides 28a and 28b can be interchangeable, or the two first lateral sides 28 can be designed as the same line type. Therefore, the length of the second lateral side 30 of the first aperture element 20C can provide the preferred scanning depth of field, and the length of the first lateral side 28 of the first aperture element 20C can increase the amount of received light and the intensity of the detection pattern.

It should be mentioned that a sum of internal angles of the first aperture element 20C can be preferably smaller than 360 degrees, and the first aperture element 20C can be formed as pillow design with the wide sides and the narrow middle for providing the desired depth of field effect; if the sum of internal angles of the aperture is greater than 360 degrees, a hole structure with narrow sides and wide middle is formed accordingly, and a middle width of the foresaid hole structure is greater than the length of the minor axis of the ellipse, making it difficult to achieve the desired depth of field effect. In addition, a dashed rectangular box within the first aperture element 20C can correspond to the first aperture element 20A shown in FIG. 2, which can indicate that the length ratio of the first lateral side 28 to the second lateral side 30 of the first aperture element 20C can be similar to the ratio of the long lateral side to the short lateral side of the first aperture element 20A.

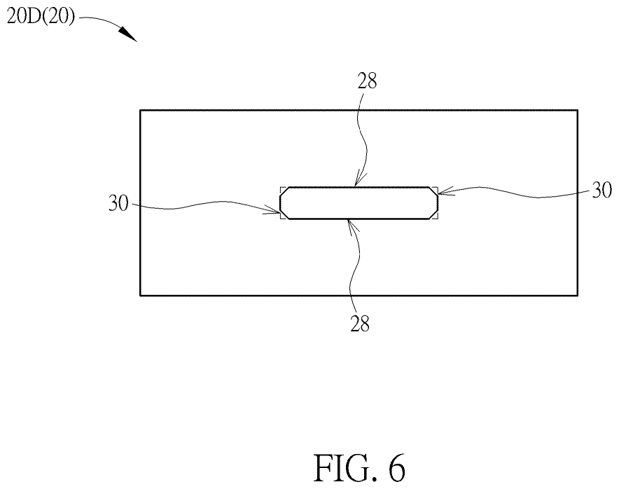

Please refer to FIG. 6. FIG. 6 is a front view of the first aperture element 20D according to a fourth embodiment of the present invention. The first aperture element 20D can have two first lateral sides 28 opposite to each other and two second lateral sides 30 opposite to each other. The first length of the first lateral side 28 can be greater than the second length of the second lateral side 30. The dashed rectangular box within the first aperture element 20D can correspond to the first aperture element 20A shown in FIG. 2, which can indicate that the length ratio of the first lateral side 28 to the second lateral side 30 of the first aperture element 20D can be similar to the ratio of the long lateral side to the short lateral side of the first aperture element 20A. The dashed rectangular box can have chamfers on four corners, so that the first aperture element 20D may be similar to the ellipse. In the fourth embodiment, the two first lateral sides 28 can have the same length or different lengths, and the two second lateral sides 30 can have the same length or different lengths; the first lateral side 28 and the second lateral side 30 can be the straight line, the arc line or the turning line.

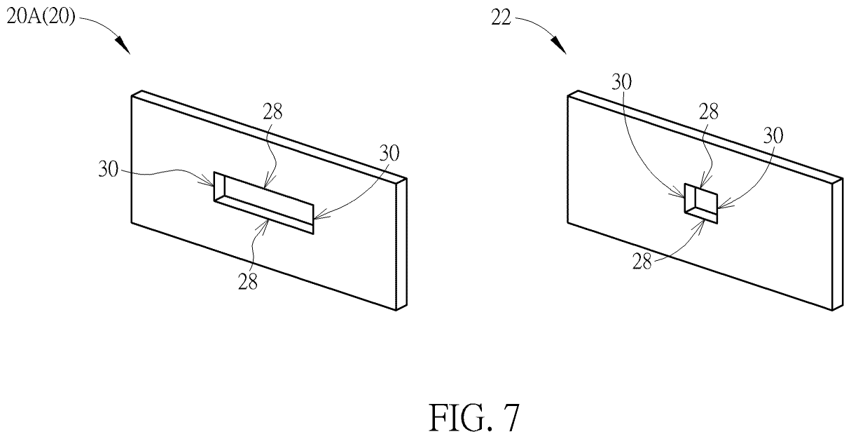

Please refer to FIG. 2 and FIG. 7. FIG. 7 is an appearance diagram of the first aperture element 20A and the second aperture element 22 according to the first embodiment of the present invention. As mentioned above, the ratio of the first length L1 to the second length L2 of the first aperture element 20A can be preferably ranged between 1:1 and 1:5, and the length ratio of the first lateral side 32 to the second lateral side 34 of the second aperture element 22 can be preferably ranged between 1:1 and 1:1.15. The first aperture element 20A and the second aperture element 22 can be preferably designed as the same structure, which means a difference between a first ratio of the first lateral side 28 to the second lateral side 30 of the first aperture element 20A and a second ratio of the first lateral side 32 to the second lateral side 34 of the second aperture element 22 can be smaller than the preset threshold. The actual value of the preset threshold can depend on the design demand of the three dimensional scanning apparatus 10, and the detailed description is omitted herein for simplicity.

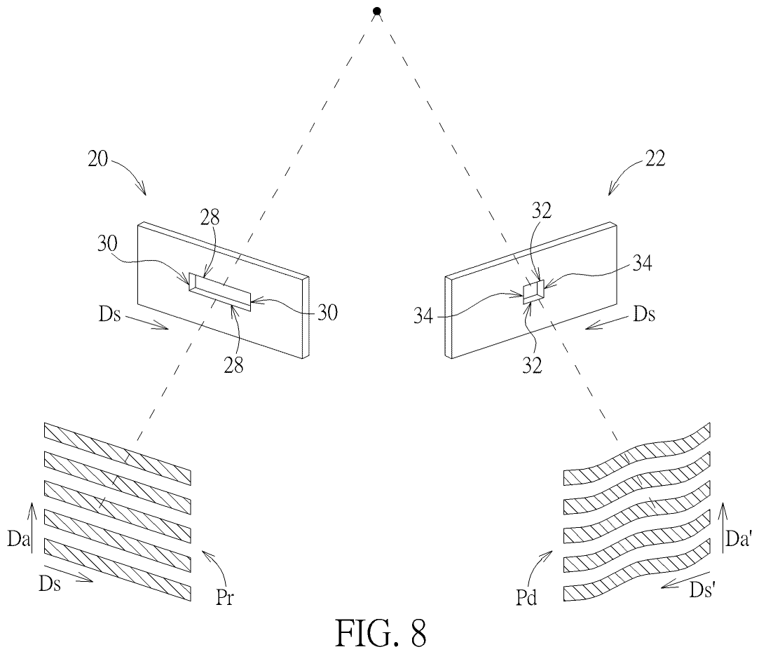

Please refer to FIG. 1, FIG. 7 and FIG. 8. FIG. 8 is a diagram of relation between the reference pattern Pr, the detection pattern Pd, the first aperture element 20 and the second aperture element 22 according to the embodiment of the present invention. The reference pattern Pr can have a plurality of stripes arranged adjacent to each other. The plurality of stripes on the reference pattern Pr can be extended in an extending direction Ds, and can be arranged in an arrangement direction Da; so the first lateral side 28 can be interpreted as being the same as the extending direction Ds but intersected with the arrangement direction Da. The detection pattern Pd causes strip deformation due to reflection from the object O. The first aperture element 20 and the second aperture element 22 can be preferably arranged with the long lateral side and/or the short lateral side aligned with each other, or can be defined as: a steering angle of the first aperture element 20 relative to the extending direction Ds or the arrangement direction Da of the reference pattern Pr can be preferably the same as or similar to a steering angle of the second aperture element 22 relative to the extending direction Ds' or the arrangement direction Da′ of the detection pattern Pd. That is to say, a first included angle between the first lateral side 28 and/or the second lateral side 30 of the first aperture element 20 and one strip (or the related extending direction Ds) of the reference pattern Pr can be the same as or similar to a second included angle between the first lateral side 32 and/or the second lateral side 34 of the second aperture element 22 and one stripe (or the related extending direction Ds) of the reference pattern Pr.

The reference pattern Pr and the first aperture element 20 (or the detection pattern Pd and the second aperture element 22) are not disposed on the same datum plane, so the first included angle and the second included angle are not marked in FIG. 8. However, the present invention may define: when the reference pattern Pr is close to the first aperture element 20 without rotation and deformation along the projection path (which means the left dotted line shown in FIG. 8), an included angle between each strip of the reference pattern Pr and the first lateral side 28 (or the second lateral side 30) can be interpreted as the first included angle; when the detection pattern Pd is close to the second aperture element 22 without rotation and deformation along the imaging path (which means the right dotted line shown in FIG. 8), an included angle between the extending direction Ds' of the detection pattern Pd and the first lateral side 28 (or the second lateral side 30) can be interpreted as the second included angle. Further, the present invention may define: the included angle between the arrangement direction Da of the reference pattern Pr and the first lateral side 28 (or the second lateral side 30) can be the first included angle, and the included angle between the arrangement direction Da′ of the detection pattern Pd and the first lateral side 32 (or the second lateral side 34) can be the second included angle.

As mentioned above, the extending direction Ds of the first lateral side 28 of the first aperture element 20 can be intersected with the arrangement direction Da of the reference pattern Pr, and the extending direction Ds of the first lateral side 32 of the second aperture element 22 can be intersected with the arrangement direction Da of the reference pattern Pr. The included angle between the first lateral side 28 (and/or the first lateral side 32) and the arrangement direction Da can preferably be ninety degrees; or the first lateral side 28 and/or the first lateral side 32 can be substantially perpendicular to the arrangement direction Da, and an angle error is allowed between the lateral sides and the arrangement direction Da. Percentage of the angle error can depend on overall optical and mechanical design of the three dimensional scanning apparatus 10, such as five percent, and the detailed description is omitted herein for simplicity.

Therefore, the first lateral side 28 of the first aperture element 20 and the first lateral side 32 of the second aperture element 22 can be extended in the extending direction Ds of the plurality of stripes, so as to maintain or keep the scanning depth of field of the three dimensional scanning apparatus 10 and increase the intensity of the detection pattern Pd; the second lateral side 30 of the first aperture element 20 and the second lateral side 34 of the second aperture element 22 can be shortened in the arrangement direction Da of the plurality of stripes, so as to maintain or keep the intensity of the detection pattern Pd and increase the scanning depth of field of the three dimensional scanning apparatus 10.

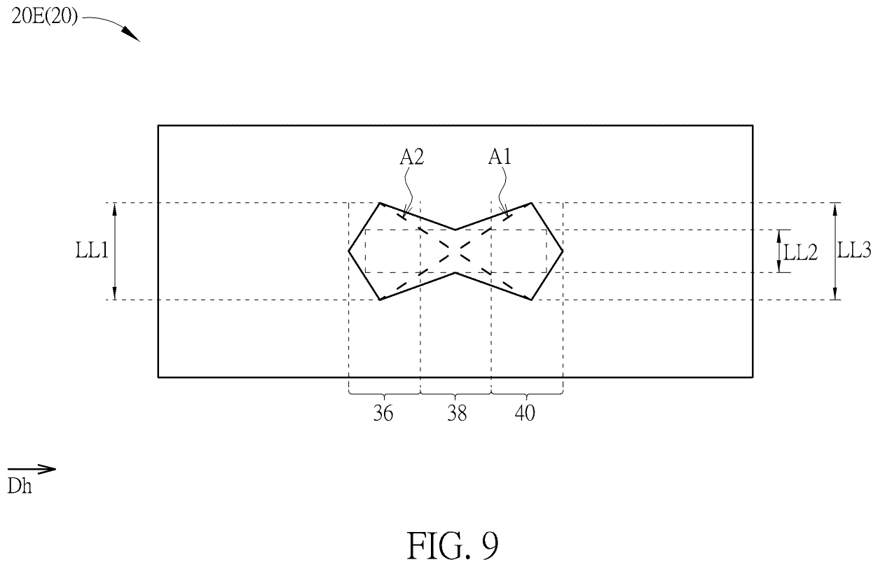

Please refer to FIG. 8 and FIG. 9. FIG. 9 is a front view of a first polygonal aperture element 20E according to a fifth embodiment of the present invention. The first aperture element 20 can be optionally designed as the first polygonal aperture element 20E, and the second aperture element 22 can be also designed as a second polygonal aperture element (which is not shown in the figures). Taking the first polygonal aperture element 20E as an example, the first polygonal aperture element 20E can include a first section 36, a second section 38 and a third section 40 adjacent to each other. The first section 36 and the third section 40 can be respectively disposed on two opposite sides of the second section 38, and an area of the second section 38 can be smaller than an area of the first section 36 and/or the third section 40. Therefore, the small area of the second section 38 can be designed to maintain or increase the scanning depth of field of the three dimensional scanning apparatus 10, and the large area of the first section 36 and the third section 40 can be designed to maintain or increase the intensity of the detection pattern Pd.

Besides, the first section 36, the second section 38 and the third section 40 can be connected with each other in a transverse direction Dh. A structurally longitudinal dimension LL1 of the first section 36 can be the same as or different from a structurally longitudinal dimension LL3 of the third section 40. The structurally longitudinal dimension LL1 of the first section 36 and the structurally longitudinal dimension LL3 of the third section 40 (which are defined as the maximal structurally longitudinal dimensions of the two sections) can be both greater than a structurally longitudinal dimension LL2 of the second section 38 (which is defined as the minimal structurally longitudinal dimension of the second section 38). The structurally longitudinal dimension LL1 can be interpreted as a length of the first section 36 in a vertical direction. The structurally longitudinal dimensions LL1, LL2 and LL3 can be orthogonal to the transverse direction Dh, and therefore the area of the first section 36 and/or the third section 40 can be greater than the area of the second section 38.

The dashed rectangular box within the first polygonal aperture element 20E can correspond to the first aperture element 20A shown in FIG. 2, and can indicate that an area ratio of the first section 36 and the third section 40 to the second section 38 of the first polygonal aperture element 20E can be similar to the ratio of the long lateral side to the short lateral side of the first aperture element 20A. In addition, the first polygonal aperture element 20E can be preferably designed as a symmetrical polygon. For example, the first polygonal aperture element 20E can have two staggered diagonal lines A1 and A2, and a length difference between the diagonal lines A1 and A2 can be smaller than the preset threshold, which means the diagonal lines A1 and A2 can have the same or similar length. The actual value of the preset threshold can depend on structural design of the first polygonal aperture element 20E, and the detailed description is omitted herein for simplicity. Drawing of the two diagonal lines A1 and A2 is not limited to the embodiment shown in FIG. 9, and can be changed in accordance with numbers of the lateral side and the corner of the first polygonal aperture element 20E.

Moreover, each lateral side of the first polygonal aperture element 20E can be the straight line or the arc line; the first polygonal aperture element 20E having the area (or the structurally longitudinal dimension) of the first section 36 and/or the third section 40 greater than the area (or the structurally longitudinal dimension) of the second section 38 can conform to a design scope of the present invention. A contour of the first polygonal aperture element 20E can be the same as, similar to, or different from a contour of the second polygonal aperture element, or can be interpreted as a contour difference between the first polygonal aperture element 20E and the second polygonal aperture element being smaller than the preset threshold. A ratio of the maximal structurally lateral dimension to the minimal structurally longitudinal dimension of the first polygonal aperture element 20E on the projection path can be ranged between 1:1 and 1:5; a ratio of the maximal structurally lateral dimension to the minimal structurally longitudinal dimension of the second polygonal aperture element on the imaging path can be ranged between 1:1 and 1:1.15.

The three dimensional scanning apparatus of the present invention can be used for the optical molding apparatus in the dental department. A light source cannot put into the mouth of the patient, and an illumination efficiency of an external light source for projecting into the patient's mouth is insufficient, so that the optical system of the optical molding apparatus has to be advanced for preferred detection accuracy. Thus, the three dimensional scanning apparatus of the present invention can adjust the shape, the ratio and/or the size of the aperture element. The aperture element with specific design can significantly increase the penetration amount of illumination beam by comparing with the elliptical aperture, so as to stably maintain the scanning depth of field and the intensity of the pattern and further acquire the accurate and clear contour of the object.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three dimensional scanning apparatus of detecting a contour of an object, the three dimensional scanning apparatus comprising:
an illumination light source adapted to emit an illumination beam;
a first aperture element;
a reference pattern generator adapted to provide a reference pattern by the illumination beam, and project the reference pattern onto the object through the first aperture element; and
an optical receiver adapted to receive a detection pattern reflected from the object, so as to analyze difference between the reference pattern and the detection pattern for acquiring the contour;
wherein the first aperture element has two first lateral sides opposite to each other and two second lateral sides opposite to each other, a first length of one of the first lateral sides is greater than a second length of one of the second lateral sides.

2. The three dimensional scanning apparatus of claim 1, wherein a ratio of the first length to the second length is ranged between 1:1 and 1:5, the two first lateral sides have the same length or different lengths, the two second lateral sides have the same length or different lengths.

3. The three dimensional scanning apparatus of claim 1, wherein the first lateral side and the second lateral side respectively are a straight line.

4. The three dimensional scanning apparatus of claim 1, wherein the first lateral side is an arc line or a turning line, and a sum of internal angles of the first aperture element is smaller than 360 degrees.

5. The three dimensional scanning apparatus of claim 1, wherein the reference pattern has a plurality of stripes arranged adjacent to each other, an extending direction of the first lateral side of the first aperture element is intersected with an arrangement direction of the plurality of stripes.

6. The three dimensional scanning apparatus of claim 5, wherein an included angle between the extending direction of the first lateral side and the arrangement direction of the plurality of stripes is ninety degrees, or the extending direction is perpendicular to the arrangement direction and an angle error is allowed between the extending direction and the arrangement direction.

7. The three dimensional scanning apparatus of claim 1, wherein the reference pattern has a plurality of stripes arranged adjacent to each other, the first lateral side of the first aperture element is extended in an extending direction of the plurality of stripes, so as to keep a scanning depth of field of the three dimensional scanning apparatus and increase an intensity of the detection pattern.

8. The three dimensional scanning apparatus of claim 1, wherein the reference pattern has a plurality of stripes arranged adjacent to each other, the second lateral side of the first aperture element is shortened in an arrangement direction of the plurality of stripes, so as to keep an intensity of the detection pattern and increase a scanning depth of field of the three dimensional scanning apparatus.

9. The three dimensional scanning apparatus of claim 1, wherein the three dimensional scanning apparatus further comprises a second aperture element, the first aperture element and the second aperture element respectively are a quadrilateral aperture; the second aperture element has two first lateral sides opposite to each other and two second lateral sides opposite to each other, a first length of one of the first lateral sides is greater than a second length of one of the second lateral sides, a ratio of the first length to the second length is ranged between 1:1 and 1:1.15.

10. The three dimensional scanning apparatus of claim 9, wherein a difference between a first ratio of the first lateral side to the second lateral side of the first aperture element and a second ratio of the first lateral side to the second lateral side of the second aperture element is smaller than a preset threshold.

11. The three dimensional scanning apparatus of claim 9, wherein a first included angle of the first lateral side and/or the second lateral side of the first aperture element relative to the reference pattern is the same as or similar to a second included angle of the first lateral side and/or the second lateral side of the second aperture element relative to the reference pattern.

12. A three dimensional scanning apparatus of detecting a contour of an object, the three dimensional scanning apparatus comprising:
an illumination light source adapted to emit an illumination beam;
a reference pattern generator adapted to provide a reference pattern by the illumination beam, and project the reference pattern onto the object;
a second aperture element; and
an optical receiver adapted to receive a detection pattern reflected from the object through the second aperture element, so as to analyze difference between the reference pattern and the detection pattern for acquiring the contour;
wherein the second aperture element has two first lateral sides opposite to each other and two second lateral sides opposite to each other, a first length of one of the first lateral sides is greater than a second length of one of the second lateral sides.

13. The three dimensional scanning apparatus of claim 12, wherein the second aperture element is a quadrilateral aperture, a ratio of the first length to the second length is ranged between 1:1 and 1:1.15, the two first lateral sides have the same length or different lengths, the two second lateral sides have the same length or different lengths, the first lateral side is a straight line or an arc line or a turning line, and a sum of internal angles of the second aperture element is smaller than 360 degrees.

14. A three dimensional scanning apparatus of detecting a contour of an object, the three dimensional scanning apparatus comprising:
an illumination light source adapted to emit an illumination beam;
a first polygonal aperture element;
a reference pattern generator adapted to provide a reference pattern by the illumination beam, and project the reference pattern onto the object through the first polygonal aperture element; and
an optical receiver adapted to receive a detection pattern reflected from the object, so as to analyze difference between the reference pattern and the detection pattern for acquiring the contour;
wherein the first polygonal aperture element comprises a first section, a second section and a third section adjacent to each other, the first section and the third section are respectively disposed on two opposite sides of the second section, an area of the second section is smaller than an area of the first section and/or the third section.

15. The three dimensional scanning apparatus of claim 14, wherein the first polygonal aperture element has two staggered diagonal lines, a length difference between the two diagonal lines is smaller than a preset threshold.

16. The three dimensional scanning apparatus of claim 14, wherein the first section, the second section and the third section are connected adjacent to each other in a transverse direction, a structurally longitudinal dimension of the first section orthogonal to the transverse direction is greater than a structurally longitudinal dimension of the second section orthogonal to the transverse direction.

17. The three dimensional scanning apparatus of claim 14, wherein each lateral side of the first polygonal aperture element is an arc line or a straight line.

18. The three dimensional scanning apparatus of claim 14, wherein a ratio of a maximal structurally lateral dimension to a minimal structurally longitudinal dimension of the first polygonal aperture element is ranged between 1:1 and 1:5.

19. The three dimensional scanning apparatus of claim 14, wherein a minimal structurally longitudinal dimension of the second section is smaller than or equal to a minimal structurally longitudinal dimension of the first section and/or the third section.

20. The three dimensional scanning apparatus of claim 14, wherein the three dimensional scanning apparatus further comprises a second polygonal aperture element, the second polygonal aperture element comprises a first section, a second section and a third section adjacent to each other, the first section and the third section are respectively disposed on two opposite sides of the second section, an area of the second section is smaller than an area of the first section and/or the third section; and a ratio of a maximal structurally lateral dimension to a minimal structurally longitudinal dimension of the second polygonal aperture element is ranged between 1:1 and 1:1.15.
